(19) United States
(12) Patent Application Publication
(10) Pub. No.: US 2024/0012382 A1
(43) Pub. Date: Jan. 11, 2024

(54) NOTIFICATION DEVICE AND COMPUTER-READABLE STORAGE MEDIUM

(71) Applicant: FANUC CORPORATION, Yamanashi (JP)

(72) Inventor: Shinichi OZEKI, Yamanashi (JP)

(21) Appl. No.: 18/250,537

(22) PCT Filed: Nov. 18, 2021
(86) PCT No.: PCT/JP2021/042374

§ 371 Date: Apr. 26, 2023

(30) Foreign Application Priority Data
Nov. 20, 2020 (JP) 2020-193515

(51) Int. Cl. G05B 19/406; G05B 19/4155

(52) U.S. Cl. CPC G05B 19/406; G05B 19/4155; G05B 2219/36529

(57) ABSTRACT

In order to improve an operation rate of an industrial machine, a notification device includes: a determination unit that determines whether an operation of an industrial machine is interrupted; and a notification unit that, when it is determined that the operation of the industrial machine is interrupted, provides interruption information indicating that the operation of the industrial machine is interrupted before the operation of the industrial machine is interrupted.

### TECHNICAL FIELD

The present invention relates to a notification device and a computer-readable storage medium.

### BACKGROUND ART

When a workpiece is machined in a machine tool, an operation of the machine tool may be interrupted during execution of a machining program. For example, when trial machining is performed in a machine tool, an operation of the machine tool is interrupted during execution of a machining program, and machining dimensions of a workpiece are measured. In addition, the operation of the machine tool is interrupted during the execution of the machining program, and the machining start position of the tool is checked by the worker.

In order to interrupt the operation of the machine tool, for example, interruption codes such as a program stop command and an optional stop command are described in the machining program. Then, after the trial machining is completed, an operation of deleting the program stop command described in the machining program or invalidating the optional stop command is performed. This enables continuous machining of the workpiece.

### CITATION LIST

### Patent Literature

Patent Literature 1: WO 2004/074953 A

### SUMMARY OF INVENTION

### Technical Problem

However, after the trial machining is completed, the worker may forget to delete the interruption code from the machining program or may forget to perform an invalidation operation. In this case, for example, the operation of the machine tool is interrupted during the night when the worker is absent, and the operation rate of the industrial machine decreases.

An object of the present invention is to prevent a decrease in an operating rate of an industrial machine.

### Solution to Problem

A notification device includes: a determination unit that determines whether an operation of an industrial machine is interrupted; and a notification unit that, when it is determined that the operation of the industrial machine is interrupted, provides interruption information indicating that the operation of the industrial machine is interrupted before the operation of the industrial machine is interrupted.

A computer-readable storage medium stores an instruction that causes a computer to: determine whether an operation of an industrial machine is interrupted; and when it is determined that the operation of the industrial machine is interrupted, provide interruption information indicating that the operation of the industrial machine is interrupted before the operation of the industrial machine is interrupted.

### Advantageous Effects of Invention

According to the present invention, an operation rate of an industrial machine can be improved.

### BRIEF DESCRIPTION OF DRAWINGS

FIG. 1 is a diagram illustrating an example of a hardware configuration of an industrial machine.

FIG. 2 is a block diagram illustrating an example of functions of a numerical controller.

FIG. 3 is a diagram illustrating an example of a machining program in which a program stop command is described.

FIG. 4 is a diagram illustrating an example of a machining program in which an optional stop command is described.

FIG. 5 is a diagram illustrating an example of a machining program in which a macro alarm command is described.

FIG. 6 is a diagram illustrating an example of a machining program in which an interruption command using a parameter input mode is described.

FIG. 7 is a diagram illustrating an example of interruption information displayed on the display device by a notification unit.

FIG. 8 is a diagram illustrating another example of interruption information displayed on the display device by the notification unit.

FIG. 9 is a diagram illustrating an example of interruption information displayed on a display device of a management server by the notification unit.

FIG. 10 is a flowchart illustrating a flow of processing executed in the numerical controller.

FIG. 11 is a diagram illustrating an example of functions of a numerical controller provided with a storage unit.

### DESCRIPTION OF EMBODIMENTS

Hereinafter, an embodiment of the present invention will be described with reference to the drawings. Note that not all combinations of features described in the following embodiments are necessarily required for solving the problem. Further, an unnecessarily detailed description may be omitted. The following description of the embodiments and the drawings are provided for those skilled in the art to fully understand the present invention, and are not intended to limit the scope of the claims.

The notification device is a device that notifies that the operation of the industrial machine is interrupted before the operation of the industrial machine is interrupted.

The notification device is, for example, a numerical controller of an industrial machine. Furthermore, the notification device may be a management server that manages the operating state of the industrial machine. Furthermore, the notification device may be a mobile terminal carried by a worker. Hereinafter, an example in which the notification device is a numerical controller will be described.

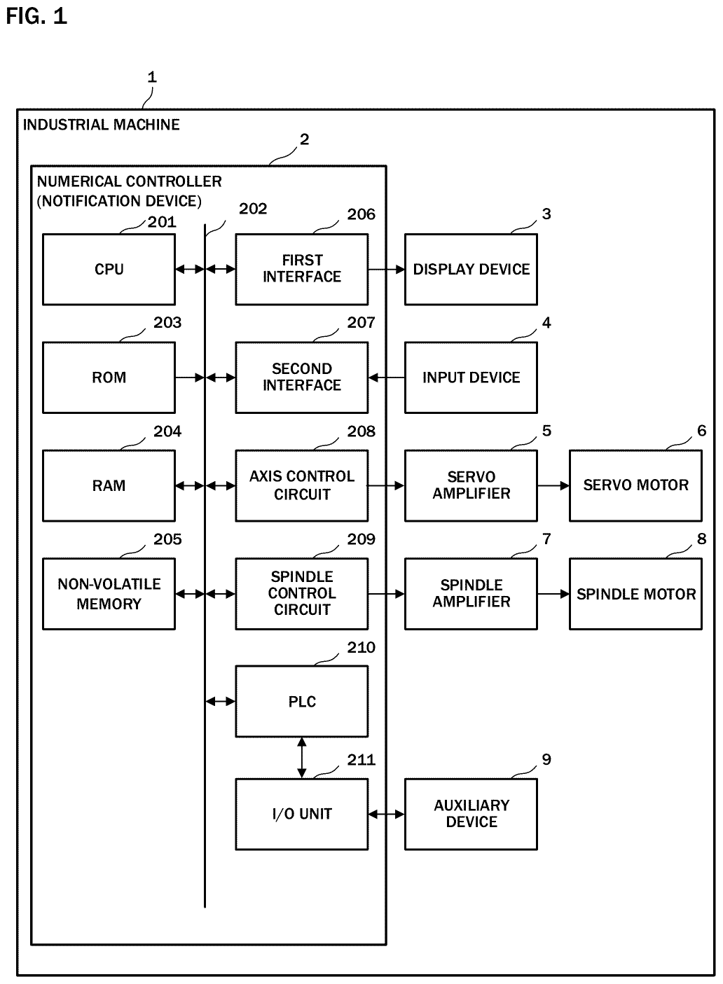

FIG. 1 is a diagram illustrating an example of a hardware configuration of an industrial machine. The industrial machine 1 is, for example, a machine tool such as a lathe or a machining center, or an industrial robot. The industrial machine 1 includes a numerical controller 2, a display device 3, an input device 4, a servo amplifier 5 and a servo motor 6, a spindle amplifier 7 and a spindle motor 8, and an auxiliary device 9.

The numerical controller 2 is a controller that controls the entire industrial machine 1. The numerical controller 2 includes a CPU 201, a bus 202, a ROM 203, a RAM 204, and a non-volatile memory 205.

The CPU 201 is a processor that controls the entire numerical controller 2 according to a system program. The CPU 201 reads a system program and the like stored in the ROM 203 via the bus 202. Furthermore, the CPU 201 controls the servo motor 6 and the spindle motor 8 according to the machining program.

The bus 202 is a communication path that interconnects individual pieces of hardware in the numerical controller 2. The individual pieces of hardware in the numerical controller 2 exchange data via the bus 202.

The ROM 203 is a storage device that stores a system program and the like for controlling the entire numerical controller 2.

The RAM 204 is a storage device that temporarily stores various data. The RAM 204 functions as a work area for the CPU 201 to process various data.

The non-volatile memory 205 is a storage device that retains data even in a state where the power supply of the industrial machine 1 is turned off and no power is supplied to the numerical controller 2. The non-volatile memory 205 includes, for example, a solid state drive (SSD).

The numerical controller 2 further includes a first interface 206, a second interface 207, an axis control circuit 208, a spindle control circuit 209, a programmable logic controller (PLC) 210, and an I/O unit 211.

The first interface 206 is an interface that connects the bus 202 and the display device 3. The first interface 206 sends, for example, various data processed by the CPU 201 to the display device 3.

The display device 3 is a device that receives various data via the first interface 206 and displays the various data. The display device 3 is a display such as a liquid crystal display (LCD).

The second interface 207 is an interface that connects the bus 202 and the input device 4. The second interface 207 sends, for example, data input from the input device 4 to the CPU 201 via the bus 202.

The input device 4 is a device for inputting various data. The input device 4 includes, for example, a keyboard and a mouse. Note that the input device 4 and the display device 3 may be configured as one device such as a touch panel, for example.

The axis control circuit 208 is a circuit that controls the servo motor 6. The axis control circuit 208 receives a control command from the CPU 201 and outputs a command for driving the servo motor 6 to the servo amplifier 5. The axis control circuit 208 sends, for example, a torque command for controlling the torque of the servo motor 6 to the servo amplifier 5.

The servo amplifier 5 receives a command from the axis control circuit 208 and supplies power to the servo motor 6.

The servo motor 6 is driven by power supplied from the servo amplifier 5. When the industrial machine 1 is a machine tool, the servo motor 6 is coupled to, for example, a ball screw for driving a tool post, a spindle head, and a table. When the servo motor 6 is driven, a structure of a machine tool, such as a tool post, a spindle head, or a table moves, for example, in the X-axis direction, the Y-axis direction, or the Z-axis direction.

The spindle control circuit 209 is a circuit for controlling the spindle motor 8. The spindle control circuit 209 receives a control command from the CPU 201 and outputs a command for driving the spindle motor 8 to the spindle amplifier 7. The spindle control circuit 209 sends, for example, a torque command for controlling the torque of the spindle motor 8 to the spindle amplifier 7.

The spindle amplifier 7 receives a command from the spindle control circuit 209 and supplies power to the spindle motor 8.

The spindle motor 8 is driven by power supplied from the spindle amplifier 7. The spindle motor 8 is coupled to the spindle and rotates the spindle.

The PLC 210 is a device that executes a ladder program to control the auxiliary device 9. The PLC 210 controls the auxiliary device 9 via the I/O unit 211.

The I/O unit 211 is an interface that connects the PLC 210 and the auxiliary device 9. The I/O unit 211 sends a command received from the PLC 210 to the auxiliary device 9.

The auxiliary device 9 is installed in the industrial machine 1 and performs an auxiliary operation when the industrial machine 1 machines a workpiece. The auxiliary device 9 may be a device installed around the industrial machine 1. The auxiliary device 9 is, for example, a tool changer, a cutting fluid injection device, or an opening/closing door drive device.

Next, an example of the functions of the numerical controller 2 will be described.

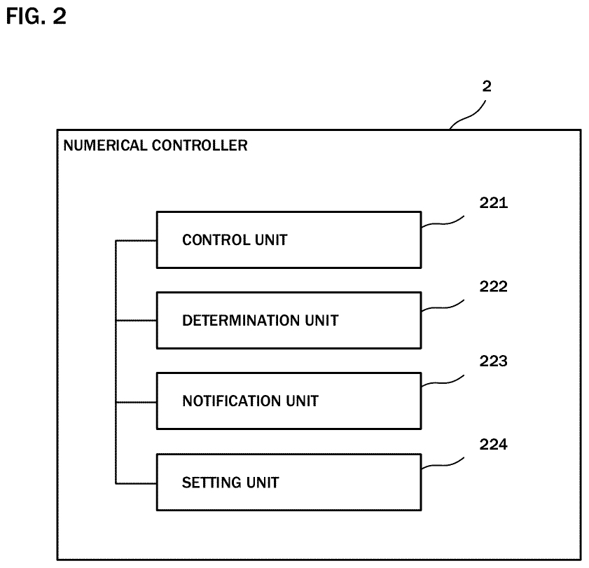

FIG. 2 is a block diagram illustrating an example of functions of the numerical controller 2. The numerical controller 2 includes a control unit 221, a determination unit 222, a notification unit 223, and a setting unit 224.

The control unit 221 controls each unit of the industrial machine 1. The control unit 221 also reads the machining program and analyzes the machining program. The control unit 221 executes the analyzed machining program to control the servo motor 6 and the spindle motor 8. Furthermore, the control unit 221 controls the operation of the auxiliary device 9 and the like.

The determination unit 222 determines whether the operation of the industrial machine 1 is interrupted. For example, the determination unit 222 determines whether an interruption code is described in the analyzed machining program. The determination unit 222 determines whether the operation of the industrial machine 1 is interrupted based on the interruption code in the machining program.

For example, the determination unit 222 determines whether the operation of the industrial machine 1 is interrupted before the execution of the machining program. The determination unit 222 may determine whether the operation of the industrial machine 1 is interrupted during the execution of the machining program.

The interruption code is a code described in the machining program for interrupting the operation of the industrial machine 1. The interruption code includes, for example, a program stop command, an optional stop command, a macro alarm command, and an interruption command using a parameter input mode. These commands are, for example, commands in international standards defined by the International Organization for Standardization, the Japanese Industrial Standards, or the like.

The interruption means that the operation of the industrial machine 1 is stopped when the interruption code described in the machining program is executed. In other words, the interruption means that the operation of the industrial machine is stopped in the middle of execution of the machining program. That is, the interruption does not mean that the execution of the machining program is terminated by a program end command. Execution of the interrupted machining program may be restarted from the line next to the line in which the interruption code is described.

The program stop command is a command for interrupting the execution of the program, that is, the operation of the industrial machine 1. The program stop command is represented by, for example, “M00”.

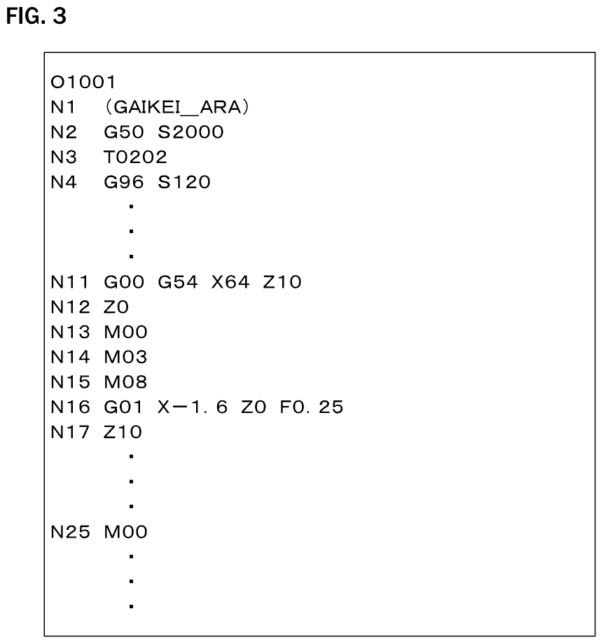

FIG. 3 is a diagram illustrating an example of a machining program in which a program stop command is described. In FIG. 3, the operation of the industrial machine 1 is always interrupted in the line in which “M00” is described. When a cycle start button is pressed in a state in which “M00” is executed and the operation of the industrial machine 1 is interrupted, the execution of the machining program is restarted from the line next to the line in which “M00” is described.

The optional stop command is a command for interrupting execution of the machining program when the optional stop is in a valid state. When the optional stop is in the valid state, for example, an optional stop button arranged on an operation panel of the numerical controller 2 is in the “on” state. The optional stop command is represented by, for example, “M01”.

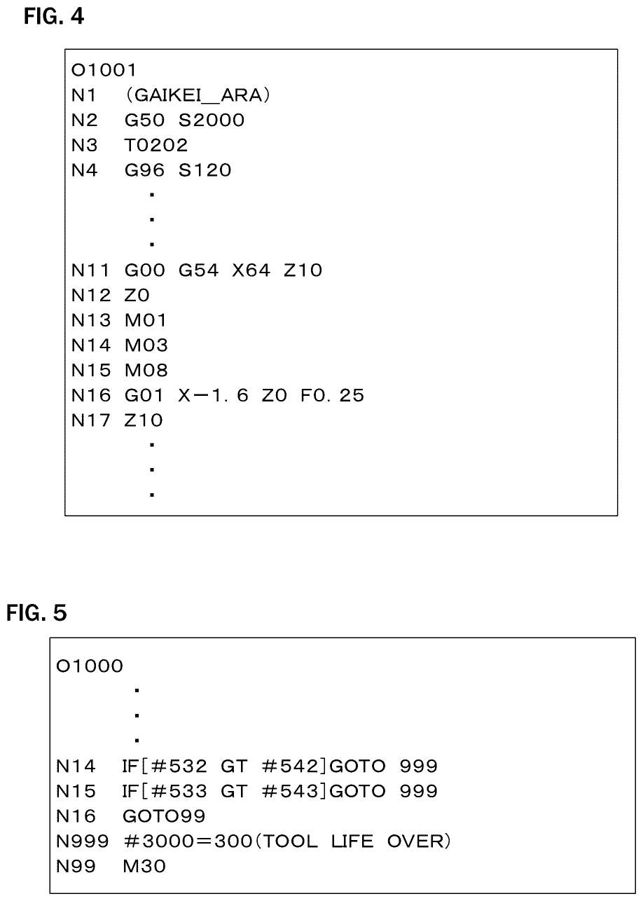

FIG. 4 is a diagram illustrating an example of a machining program in which an optional stop command is described. When the optional stop is in the valid state, the operation of the industrial machine 1 is interrupted in the line in which “M01” is described. When the cycle start button is pressed in a state in which “M01” is executed and the operation of the industrial machine 1 is interrupted, the execution of the machining program is restarted from the line next to the line in which “M01” is described.

The macro alarm command is a command that can cause the numerical controller 2 to output an alarm to interrupt the operation of the industrial machine 1 when a predetermined interruption condition is satisfied. The macro alarm command is represented by, for example, “#3000”.

FIG. 5 is a diagram illustrating an example of a machining program in which a macro alarm command is described. In FIG. 5, it is described in the line of the sequence number N14 that the sequence moves to the line of the sequence number N999 when #532 is larger than #542. It is described in the line of the sequence number N15 that the sequence moves to the line of the sequence number N999 when #533 is larger than #543. It is described in the line of the sequence number N999 that an alarm 300 is output.

Here, #532 and #533 are variables that store data indicating actual use times of a first tool and a second tool, respectively. #542 and #543 are variables that store data indicating the tool life of the first tool and the tool life of the second tool set in advance, respectively. That is, the machining program illustrated in FIG. 5 causes the numerical controller 2 to output an alarm and interrupt the operation of the industrial machine 1 by executing the macro alarm command “#3000” when the first tool or the second tool reaches their tool life.

The interruption command using the parameter input mode is a command for interrupting the operation of the industrial machine 1 by setting a parameter value in the machining program. By an interruption command using the parameter input mode, for example, the feedrate of the tool in each axial direction can be set to 0 [mm/rev], and the operation of the industrial machine 1 can be interrupted.

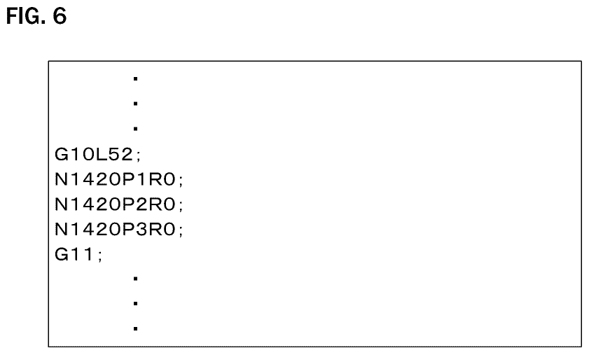

FIG. 6 is a diagram illustrating an example of a machining program in which an interruption command using a parameter input mode is described. The interruption code illustrated in FIG. 6 is a code for setting the feedrate in the X axis, the Y axis, and the Z axis to 0 [mm/rev]. Specifically, the parameter input mode is set in “G10L52”. In “N1420P1R0;”, the feed speed in the X axis is set to 0 [mm/rev]. In “N1420P2R0;”, the feed speed in the Y axis is set to 0 [mm/rev]. In “N1420P3R0;”, the feed speed in the Z axis is set to 0 [mm/rev]. By describing the interruption command in the machining program using the parameter input mode, the operation of each axis can be stopped to interrupt the operation of the industrial machine.

Here, referring back to FIG. 2, the description of the function of the numerical controller 2 will be continued.

Further, when an interruption code is described in the machining program, the determination unit 222 may calculate time information regarding the time when the interruption code is executed and the operation of the industrial machine 1 is interrupted. The time information regarding the time when the operation of the industrial machine 1 is interrupted is information indicating the time when the operation of the industrial machine 1 is interrupted or information indicating the time until the operation of the industrial machine 1 is interrupted. The information indicating the time until the operation of the industrial machine 1 is interrupted is real-time information. That is, the time until the operation of the industrial machine 1 is interrupted decreases with the lapse of time, and indicates “0” when the operation of the industrial machine 1 is interrupted.

For example, when the machining program is analyzed, the determination unit 222 performs machining simulation. In the machining simulation, the determination unit 222 calculates time information regarding the time when the interruption code described in the machining program is executed and the operation of the industrial machine 1 is interrupted. When performing the machining simulation, the determination unit 222 may use various parameters set in the numerical controller 2.

In a case where it is determined that the operation of the industrial machine 1 is interrupted, the notification unit 223 provides interruption information indicating that the operation of the industrial machine 1 is interrupted before the operation of the industrial machine 1 is interrupted. For example, the notification unit 223 provides the interruption information by causing the display device 3 to display the interruption information.

The interruption information is, for example, an icon indicating that the operation of the industrial machine 1 is interrupted during the execution of the machining program, and time information regarding the time when the operation of the industrial machine 1 is interrupted, which is calculated by the determination unit 222.

The time before the operation of the industrial machine 1 is interrupted is, for example, when the cycle start button is pressed and the execution of the machining program is started. Further, the time before the operation of the industrial machine 1 is interrupted may be when the machining program is being executed.

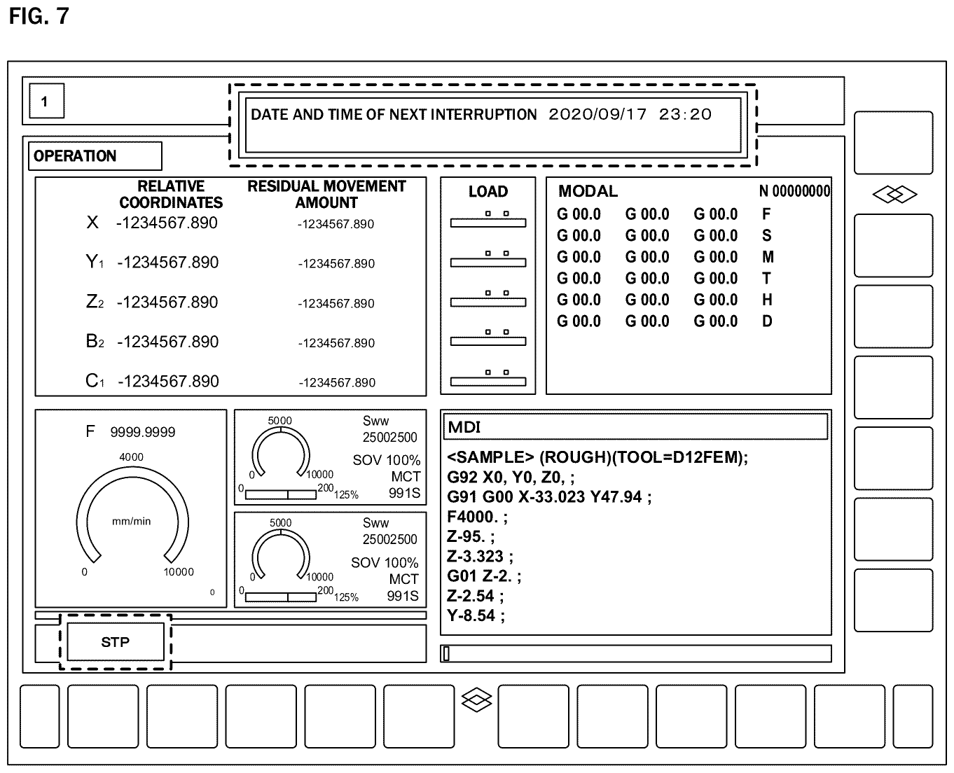

FIG. 7 is a diagram illustrating an example of interruption information displayed on the display device 3 by the notification unit 223. As illustrated in FIG. 7, the interruption information is, for example, an icon “STP” indicating that the operation of the industrial machine 1 is interrupted. In this case, the worker sees the display of the icon “STP” and recognizes that the operation of the industrial machine 1 is interrupted.

In addition, the interruption information is, for example, time information regarding the time when the operation of the industrial machine 1 is interrupted. FIG. 7 displays the date and time when the operation of the industrial machine 1 is interrupted. Although the icon and the time information are displayed at the same time in FIG. 7, only one of the icon and the time information may be displayed.

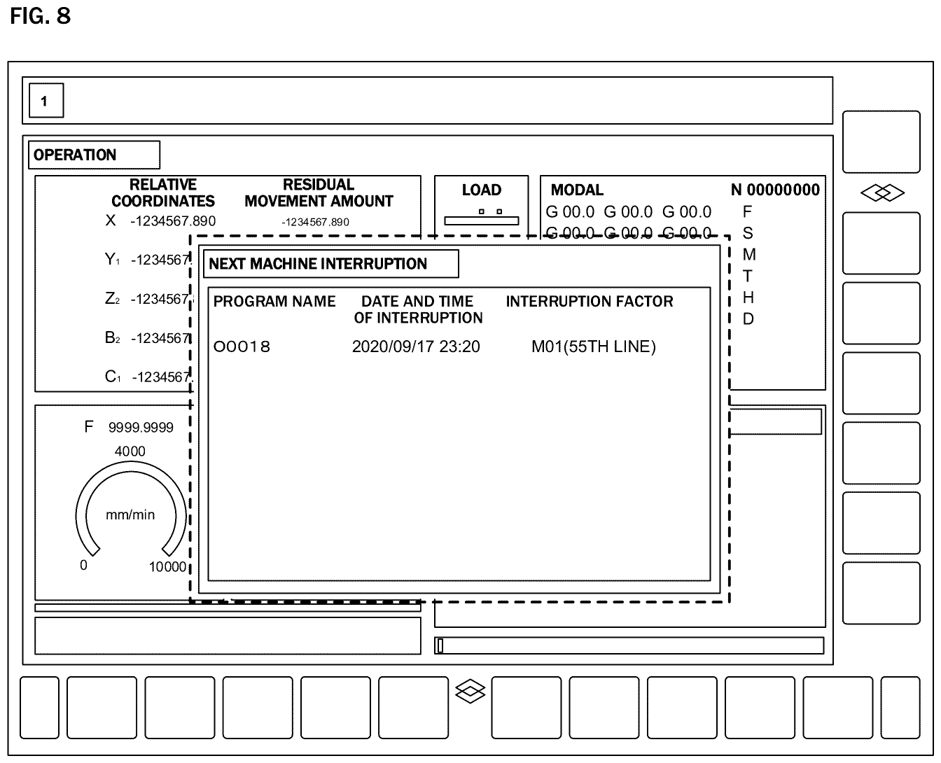

FIG. 8 is a diagram illustrating another example of interruption information displayed on the display device 3 by the notification unit 223. In FIG. 8, an interruption information window displays a program name “O0018”, an interruption date and time “2020/09/17/23:20”, and an interruption factor “M01 (line 55)”. That is, the interruption information window indicates that the operation of the industrial machine 1 is interrupted at 11:20 PM on Sep. 17, 2020 by the interruption code “M01” described in the 55th line of the machining program “O0018” being executed.

The notification unit 223 may display the interruption information on a display device of a management server that manages the operating state of the industrial machine 1.

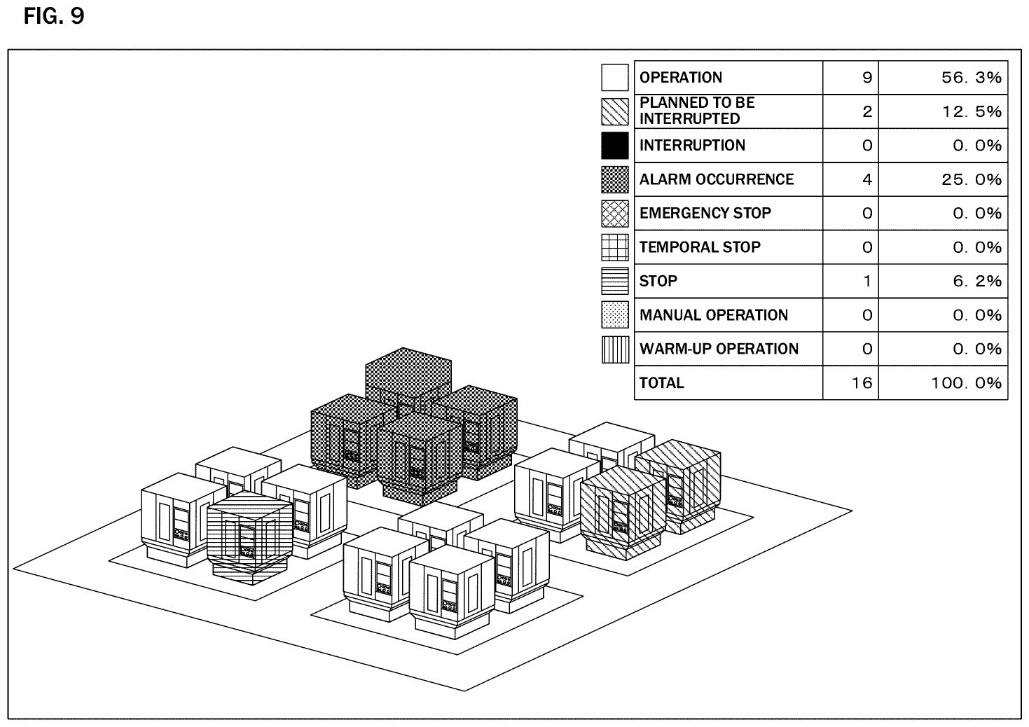

FIG. 9 is a diagram illustrating an example of interruption information displayed on the display device of a management server by the notification unit 223. The management server displays, on a display screen, the operation status of an industrial machine 1 arranged in a factory. The management server displays, for example, the number of industrial machines 1 in operation statuses such as “operation”, “alarm occurrence”, and “emergency stop”, and the ratio of the number of the industrial machines 1 in these operation statuses to the total number of the industrial machines 1. In addition, the management server displays the number of the industrial machines 1 the operation of which is interrupted among the industrial machines 1 in operation and a ratio of the industrial machines 1 the operation of which is interrupted to the total number. In addition, the management server displays the model of each industrial machine 1 so that the operation status of each model can be identified by color. In this case, the worker can check in which industrial machine 1 the operation is interrupted by checking the display screen of the display device.

The setting unit 224 enables or disables the notification by the notification unit 223. For example, when the worker performs an operation for enabling or disabling the notification by the notification unit 223, the setting unit 224 enables or disables the notification by the notification unit 223. When the setting unit 224 disables the notification by the notification unit 223, the notification unit 223 does not provide the interruption information. That is, the notification unit 223 determines whether the notification by the notification unit 223 is enabled or disabled and then performs the notification.

Furthermore, the setting unit 224 sets a notification condition that enables notification by the notification unit 223. For example, when the worker performs an operation for setting a notification condition that enables the notification by the notification unit 223, the setting unit 224 sets a notification condition that enables the notification by the notification unit 223. The notification condition includes information regarding a date and time.

For example, the setting unit 224 enables notification by the notification unit 223 and sets a date and time such as “2020/11/11/7:00” as a notification condition. In this case, the notification unit 223 determines whether the interruption code included in the machining program causes the operation of the industrial machine 1 to be interrupted by 7:00 AM on Nov. 11, 2020. When the operation of the industrial machine 1 is interrupted by 7:00 AM on Nov. 11, 2020 by the interruption code included in the machining program, the notification unit 223 provides interruption information indicating the time when the operation of the industrial machine 1 is interrupted, for example. In addition, when the operation of the industrial machine 1 is not interrupted by 7:00 AM on Nov. 11, 2020 by the interruption code included in the machining program, the notification unit 223 does not provide the interruption information.

Furthermore, the setting unit 224 may enable notification by the notification unit 223 and set a time such as “7:00” as a notification condition. In this case, when an interruption code for interrupting the operation of the industrial machine 1 within 7 hours is included in the machining program, the notification unit 223 provides the interruption information.

Next, a flow of processing executed in the numerical controller 2 will be described.

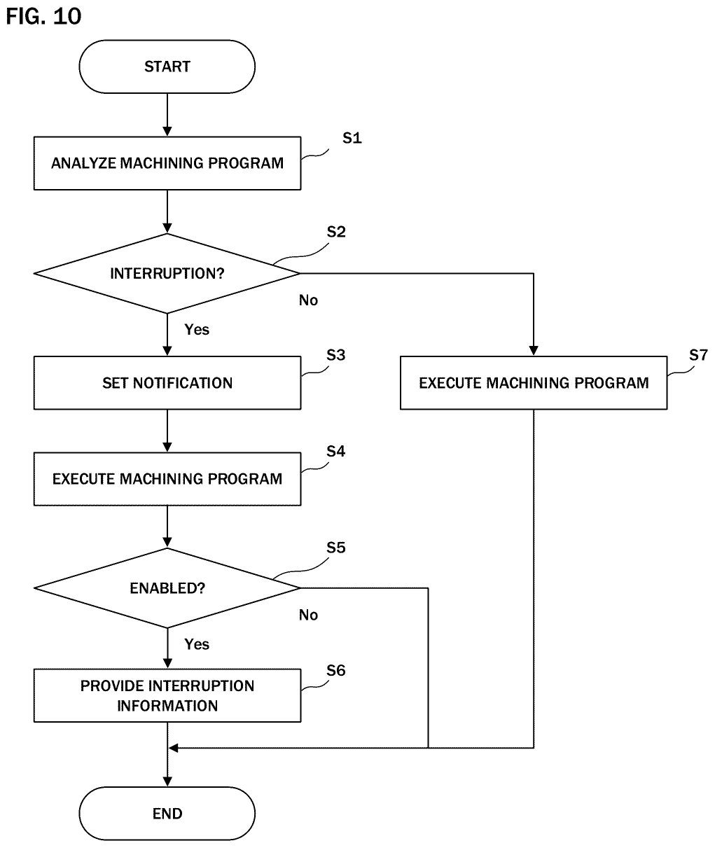

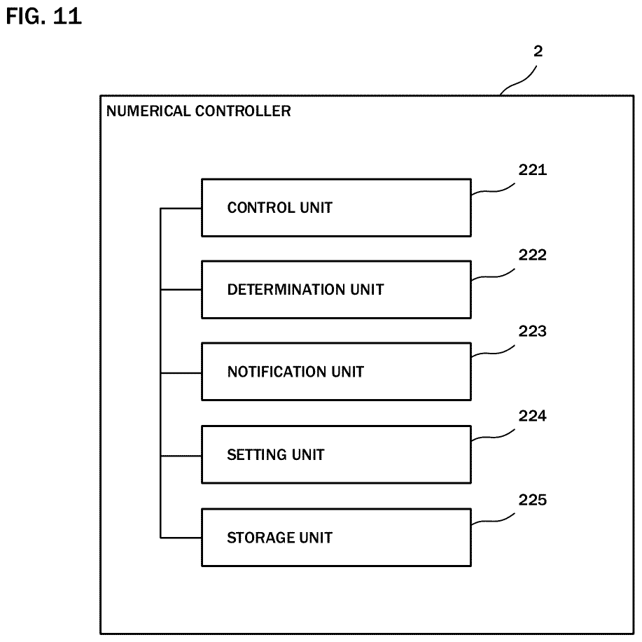

FIG. 10 is a flowchart illustrating an example of a flow of processing executed in the numerical controller 2.

First, the control unit 221 reads a machining program and analyzes the machining program (step S1).

Next, the determination unit 222 determines whether the operation of the industrial machine 1 is interrupted (step S2).

When the determination unit 222 determines that the operation of the industrial machine 1 is to be stopped (in the case of Yes in step S2), the setting unit 224 enables or disables the notification by the notification unit 223 (step S3).

Next, when the cycle start button is pressed, the control unit 221 executes a machining program (step S4).

Next, the notification unit 223 determines whether the notification by the notification unit 223 is enabled (step S5).

When the notification by the notification unit 223 is enabled (in the case of Yes in step S5), the notification unit 223 provides interruption information (step S6). Thereafter, when the execution of the machining program is completed, the process ends.

On the other hand, when the determination unit 222 determines that the operation of the industrial machine 1 is not stopped during the execution of the machining program (in the case of No in step S2), the control unit 221 executes the machining program when the cycle start button is pressed (step S7). Thereafter, when the execution of the machining program is completed, the process ends.

In addition, when the notification by the notification unit 223 is disabled (in the case of No in step S5), the notification unit 223 does not provide the interruption information.

As described above, the notification device 2 includes: the determination unit 222 that determines whether the operation of the industrial machine 1 is interrupted; and the notification unit 223 that, when it is determined that the operation of the industrial machine 1 is interrupted, provides the interruption information indicating that the operation of the industrial machine 1 is interrupted before the operation of the industrial machine 1 is interrupted.

Therefore, the notification device 2 can notify the worker of interruption of the operation of the industrial machine 1 during the execution of the machining program before the operation of the industrial machine 1 is interrupted. As a result, it is possible to prevent the worker from forgetting to delete the interruption code from the machining program or forgetting to perform the operation of disabling the interruption code.

In addition, the determination unit 222 of the notification device 2 determines whether the operation of the industrial machine 1 is interrupted based on the interruption code in the machining program. Furthermore, the interruption code includes at least one of a program stop command, an optional stop command, a macro alarm command, and an interruption command using a parameter input mode. Therefore, the determination unit 222 can determine whether the operation of the industrial machine 1 is interrupted at the moment when the machining program is analyzed.

In addition, the interruption information includes time information regarding the time when the operation of the industrial machine 1 is interrupted. Therefore, the worker can confirm when the operation of the industrial machine 1 is interrupted.

In addition, the notification unit 223 notifies the display screen of the display device, of the interruption information. Therefore, the worker can easily confirm the interruption information when pressing the cycle start button. Alternatively, a manager of the factory can easily confirm when the operation of the industrial machine 1 in the factory is interrupted.

In addition, the notification device 2 further includes the setting unit 224 that enables or disables the notification by the notification unit 223. Therefore, it is possible to prevent unnecessary notification by setting the notification to be disabled at the time of trial machining or the like.

Furthermore, the setting unit 224 further sets a notification condition that enables the notification by the notification unit 223. Therefore, for example, the notification unit 223 can notify that the operation of the industrial machine 1 is interrupted only in a time zone in which the worker cannot respond even if the operation of the industrial machine 1 is interrupted, such as at night.

In the embodiment described above, it is determined whether the operation of the industrial machine 1 is interrupted during the execution of the machining program based on the interruption code in the machining program. However, the notification device 2 may provide the interruption information indicating that the operation of the industrial machine 1 is interrupted based on result information indicating that the operation of the industrial machine 1 is interrupted.

In this case, the notification device 2 further includes a storage unit that stores interruption result information indicating that the interruption of the operation of the industrial machine 1 is executed when the interruption of the operation of the industrial machine 1 is executed, and the notification unit 223 provides the interruption information indicating that the operation of the industrial machine 1 is interrupted before the operation of the industrial machine 1 is interrupted based on the interruption result information stored in the storage unit.

FIG. 11 is a diagram illustrating an example of functions of a numerical controller provided with a storage unit. The storage unit 225 stores interruption result information indicating that the interruption of the operation of the industrial machine 1 has been executed. The interruption result information is, for example, time information regarding the time when the interruption code in the machining program is executed and the operation of the industrial machine 1 is interrupted. In this case, the time information is information indicating a time from when the execution of the program is started to when the interruption code is executed and the operation of the industrial machine 1 is interrupted.

The interruption result information in a case where trial machining is performed will be described with reference to FIG. 3. When the machining program illustrated in FIG. 3 is executed, the storage unit 225 stores the interruption result information indicating the time from when the execution of the machining program is started to when the operation of the industrial machine 1 is interrupted by the program stop command described in the line of the sequence number N13. In addition, the storage unit 225 stores the interruption result information indicating the time from when the execution of the command described in the line of the sequence number N14 is restarted to when the operation of the industrial machine 1 is interrupted by the program stop command of the sequence number N25.

Next, in a case where the second and subsequent machining operations after the trial machining is performed, the notification unit 223 provides the interruption information based on the interruption result information stored in the storage unit 225. Specifically, the notification unit 223 provides the interruption information indicating the time from when the execution of the machining program is started to when the operation of the industrial machine 1 is interrupted by the program stop command described in the line of the sequence number N13. In addition, the notification unit 223 provides the interruption information indicating the time from when the execution of the command described in the line of the sequence number N14 is restarted to when the operation of the industrial machine 1 is interrupted by the program stop command of the sequence number N25.

As a result, the notification device 2 can provide the interruption information indicating that the operation of the industrial machine 1 is interrupted based on the interruption result information without analyzing the machining program in the second and subsequent machining operations. Therefore, the analysis time of the machining program can be reduced at the time of the second and subsequent machining operations.

### REFERENCE SIGNS LIST

1 Industrial machine

2 Numerical controller (notification device)

201 CPU

202 Bus

203 ROM

204 RAM

205 Non-volatile memory

206 First interface

207 Second interface

208 Axis control circuit

209 Spindle control circuit

210 PLC

211 I/O unit

221 Control unit

222 Determination unit

223 Notification unit

224 Setting unit

225 Storage unit

3 Display device

4 Input device

5 Servo amplifier

6 Servo motor

7 Spindle amplifier

8 Spindle motor

9 Auxiliary device

1. A notification device comprising:
a determination unit that determines whether an operation of an industrial machine is interrupted; and
a notification unit that, when it is determined that the operation of the industrial machine is interrupted, provides interruption information indicating that the operation of the industrial machine is interrupted before the operation of the industrial machine is interrupted.

2. The notification device according to claim 1, wherein the determination unit determines whether the operation of the industrial machine is interrupted based on an interruption code in a machining program.

3. The notification device according to claim 1, further comprising a storage unit that stores interruption result information indicating that the operation of the industrial machine is interrupted when the operation of the industrial machine is interrupted, and
the notification unit provides the interruption information indicating that the operation of the industrial machine is interrupted before the operation of the industrial machine is interrupted, based on the interruption result information stored in the storage unit.

4. The notification device according to claim 2, wherein the interruption code includes at least one of a program stop command, an optional stop command, a macro alarm command, and an interruption command using a parameter input mode.

5. The notification device according to claim 1, wherein the interruption information includes time information regarding time when the operation of the industrial machine is interrupted.

6. The notification device according to claim 1, wherein the notification unit provides the interruption information by displaying the interruption information on a display screen of a display device.

7. The notification device according to claim 1, further comprising a setting unit that enables or disables notification of the interruption information by the notification unit.

8. The notification device according to claim 7, wherein the setting unit further sets a notification condition that enables notification of the interruption information by the notification unit.

9. A computer-readable storage medium storing an instruction that causes a computer to: determine whether an operation of an industrial machine is interrupted; and
when it is determined that the operation of the industrial machine is interrupted, provide interruption information indicating that the operation of the industrial machine is interrupted before the operation of the industrial machine is interrupted.
